(19) United States
(12) Patent Application Publication
(10) Pub. No.: US 2008/0106529 A1
(43) Pub. Date: May 8, 2008

(54) PROCESSING METHODS AND SYSTEMS FOR DRIVERS

(75) Inventors: Jing Shun Lin, Yilan County (TW); Chao Lien Tsai, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, Taoyuan (TW)

(21) Appl. No.: 11/560,318

(22) Filed: Nov. 15, 2006

(30) Foreign Application Priority Data
Nov. 17, 2005 (TW) TW94140416

(51) Int. Cl. G06F 3/038

(52) U.S. Cl. 345/204

(57) ABSTRACT

Methods for processing a driver in a portable electronic device are provided. The driver drives the portable electronic device and is stored in a storage unit thereof. The portable electronic device is first coupled to a computer system. The storage unit turns to a storage device of the computer system after coupling. A label of the storage device is then detected. The label specifies the state of the driver. The driver is processed according to the label.

### BACKGROUND

The invention relates to driver processing methods, and in particular to methods of installing and updating drivers for a portable electronic device.

This section is intended to introduce the reader to various aspects of art, which may be related to various aspects of the invention, which are described and/or claimed below. This discussion is intended to be helpful in providing the reader with background information to facilitate a better understanding of the various aspects of the invention. Accordingly, it should be understood that these statements are to be read in this light, and not as admissions of related art.

Digital cameras are popular image capture devices. Images captured by a digital camera are stored as digital image files in a built-in memory medium or a replaceable memory card of the digital camera, and are processed by image processing software in a computer system.

Digital cameras and other portable electronic devices, such as personal digital assistants and mobile phones, are quipped storage units. When a portable electronic device comprising a storage unit is linked with a computer system through a USB cable, the storage unit of the portable electronic device can be regarded as a storage device for the computer system, and accessed via a file management system of the computer system.

For a conventional portable electronic device, a driver for coupling with a computer system is required. Particularly, when the portable electronic device and the computer system are coupled for the first time, an appropriate driver enables data transmission therebetween.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass numerous aspects that may not be set forth below.

A method for processing a driver in a portable electronic device, wherein the driver is stored in a storage unit of the portable electronic device, and used to drive the portable electronic device. The portable electronic device is connected to a computer system, wherein the storage unit for the portable electronic device serves as a storage device of the computer system after the connection. A label of the storage device is detected, wherein the label specifies a status of the driver. The driver is processed according to the label.

Also provided is a storage medium for storing a computer program providing the described method for processing a driver.

Also provided is a system for processing a driver in a portable electronic device, wherein the driver is stored in a storage unit of the portable electronic device, and the driver drives the portable electronic device. A connection device, connects the portable electronic device to a computer system, wherein the storage unit of the portable electronic device serves as a storage device of the computer system after the connection. A detection device, detects a label of the storage device, wherein the label specifies a status of the driver. A processor, coupled to the detection device, processes the driver according to the label.

### BRIEF DESCRIPTION OF DRAWINGS

The invention can be more fully understood by reading the subsequent detailed description and examples with references made to the accompanying drawings, wherein:

FIG. 1a is a flowchart of an embodiment of a method for processing a driver;

FIG. 1b is a detailed flowchart of an embodiment of the method of FIG. 1a;

FIG. 2 is a diagram of an embodiment of a storage medium for storing a computer program providing the method for processing a driver;

FIG. 3 is a schematic functional block diagram showing functional components of an embodiment of a system for processing a driver;

FIG. 4a illustrates an embodiment of a method for processing a driver; and

FIG. 4b illustrates another embodiment of a method for processing a driver.

### DETAILED DESCRIPTION

One or more specific embodiments of the invention are described in the following. In an effort to provide a concise description of these embodiments, not all features of an actual implementation are described in the specification. It should be appreciated that in the development of any such actual implementation, as in any engineering or design project, numerous implementation-specific decisions must be made to achieve the specific goals of the developers, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be take n in a limiting sense. The leading digit of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

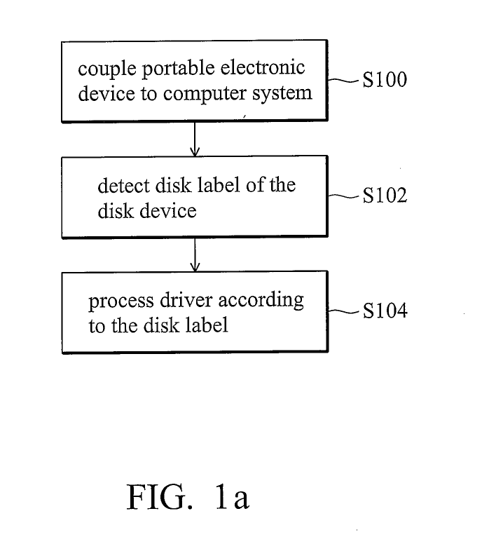

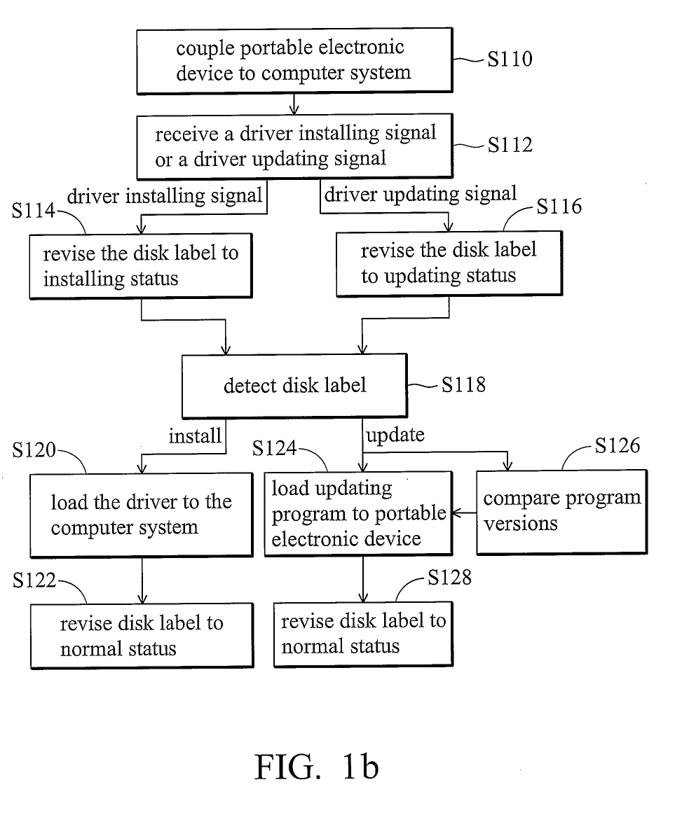

FIG. 1a is a flowchart of an embodiment of a method for processing a driver. According to this embodiment, a method for processing a driver of a portable electronic device, such as a digital camera. The driver is stored in a storage unit of the portable electronic device, and the driver drives the portable electronic device.

The portable electronic device is connected to a computer system through a connection device, such as a USB cable (step S100). The storage unit of the portable electronic device serves as a storage device of the computer system after the connection.

A label of the storage device is detected (step S102), wherein the detection is executed by the computer system or the portable electronic device. The label specifies a status of the driver. The driver is processed according to the label (step S104).

The label specifies a normal, install, or update status of the driver. When the label status is normal, no further driver processing is required. When the label specifies an install status, the computer system requires installation of a driver. When the label status is update, an update program stored in the computer system is used to update the driver of the portable electronic device.

FIG. 1b is a detailed flowchart of an embodiment of the method of FIG. 1a. The portable electronic device is connected to a computer system through a connection device, such as a USB cable (step S110). The storage unit of the portable electronic device serves as a storage device of the computer system after the connection. Before a label is detected, a driver install signal or a driver update signal is received from the computer system (step S112). When a driver install signal is received from the computer system, the label is revised to specify an install status (step S114). When a driver update signal is received from the computer system, the label is revised to specify an update status (step S116).

The label of the storage device is detected (step S118). When the label specifies an install status, the driver is loaded from the portable electronic device into the computer system (step S120), and the label is revised to specify a normal status (step S122).

When the label status is update, an update program is loaded from the computer system to the portable electronic device (step S124), and the label is revised to specify a normal status (step S128). Versions of the driver and an update program stored in the computer system can be compared (step S126), when the version of the update program is more current than the driver, the update program is loaded from the computer system to the portable electronic device (step S124), and the label is revised to specify a normal status (step S128).

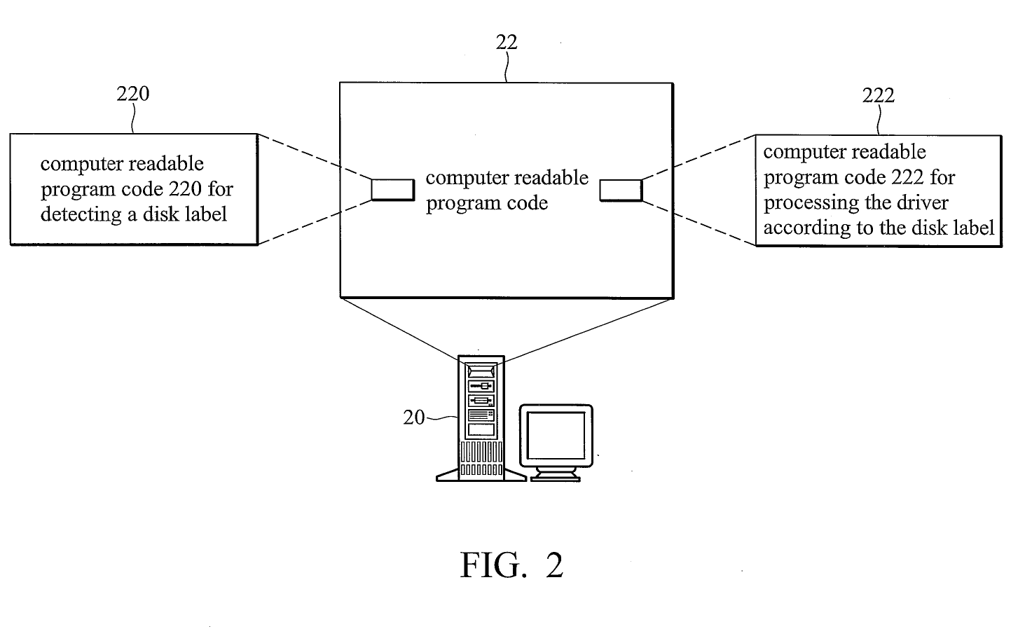

FIG. 2 is a diagram of an embodiment of a storage medium for storing a computer program providing a method for processing a driver. The computer system comprises a computer usable storage medium 20 having computer readable program code 22 embodied in the medium, comprising computer readable program code 220 for detecting a label, and a computer readable program code 222 for processing the driver according to the label.

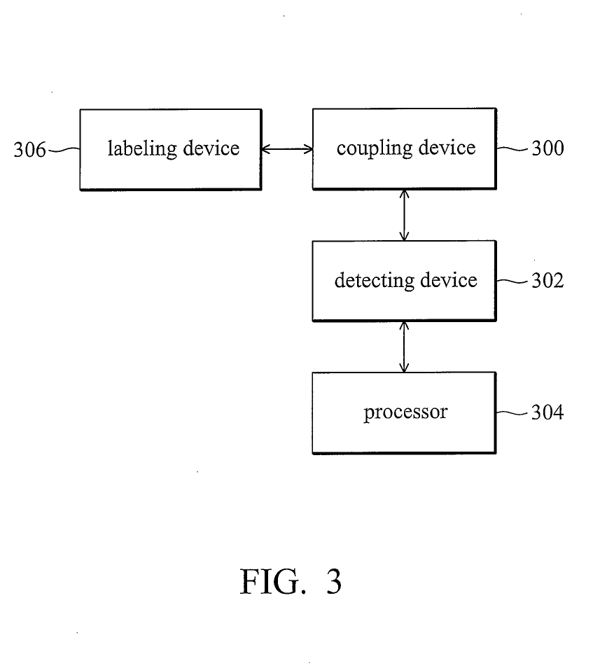

FIG. 3 is a schematic functional block diagram showing functional components of an embodiment of a system for processing a driver. According to this embodiment, a system for processing a driver of a portable electronic device, such as a digital camera, is provided, wherein the driver is stored in a storage unit of the portable electronic device, and the driver drives the portable electronic device. The system comprises a connection device 300, a detection device 302, and a processor 304.

The connection device 300 connects the portable electronic device to the computer system, the connection device 300 can be a USB (universal series bus) cable. The storage unit of the portable electronic device serves as a storage device of the computer system after the connection.

The detection device 302 detects a label of the storage device (the storage unit of the portable electronic device), wherein the label specifies a status of the driver. The detection device 302 may be set in the computer system or the portable electronic device. The processor 304 processes the driver according to the label.

The system can further comprise a labeling device 306, coupled to the connection device, writing the label to specify a normal, generating, or update status of the driver. The computer system or the portable electronic device comprises labeling device 306. Before the detection device 302 detects the label, the labeling device 306 receives a driver install signal from the computer system, and revises the label to specify a generating status. Additionally, before the detection device detects the label, the labeling device 306 may receive a driver update signal from the computer system, and revise the label to specify an update status.

When the label specifies a generating status, the processor 304 loads the driver into the computer system, and revises the label to specify a normal status. When the label status is update, the processor 304 loads an update program from the computer system to the portable electronic device to update the driver of the portable electronic device, and revises the label to specify a normal status. Additionally, when the label status is update, the processor 304 may compare versions of the driver and an update program in the computer system, load the update program from the computer system to the portable electronic device when the version of the update program is more current than the driver, and revise the label to specify a normal status.

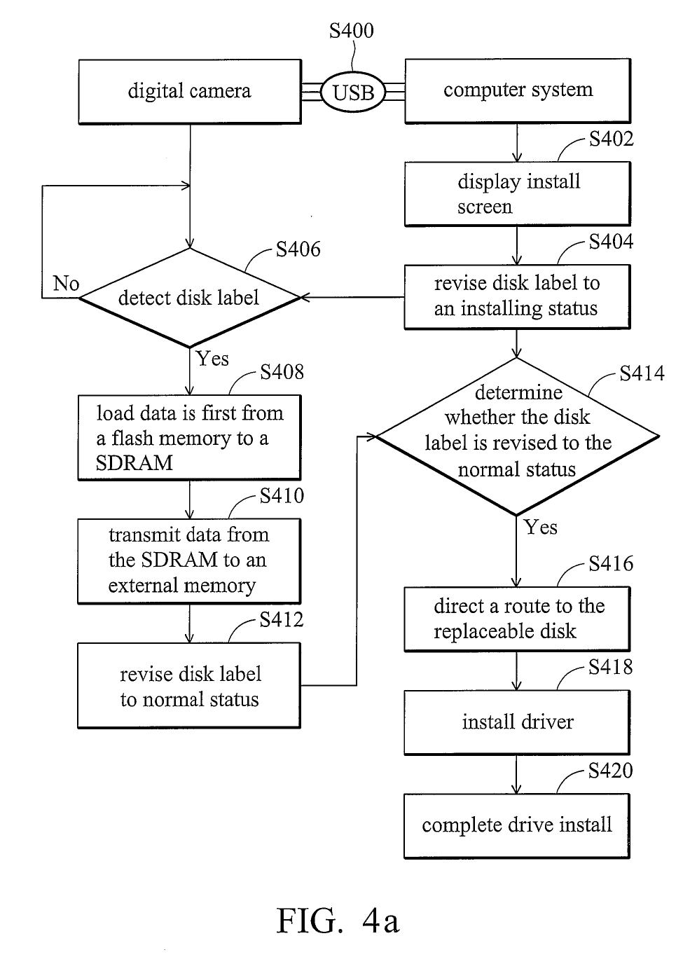

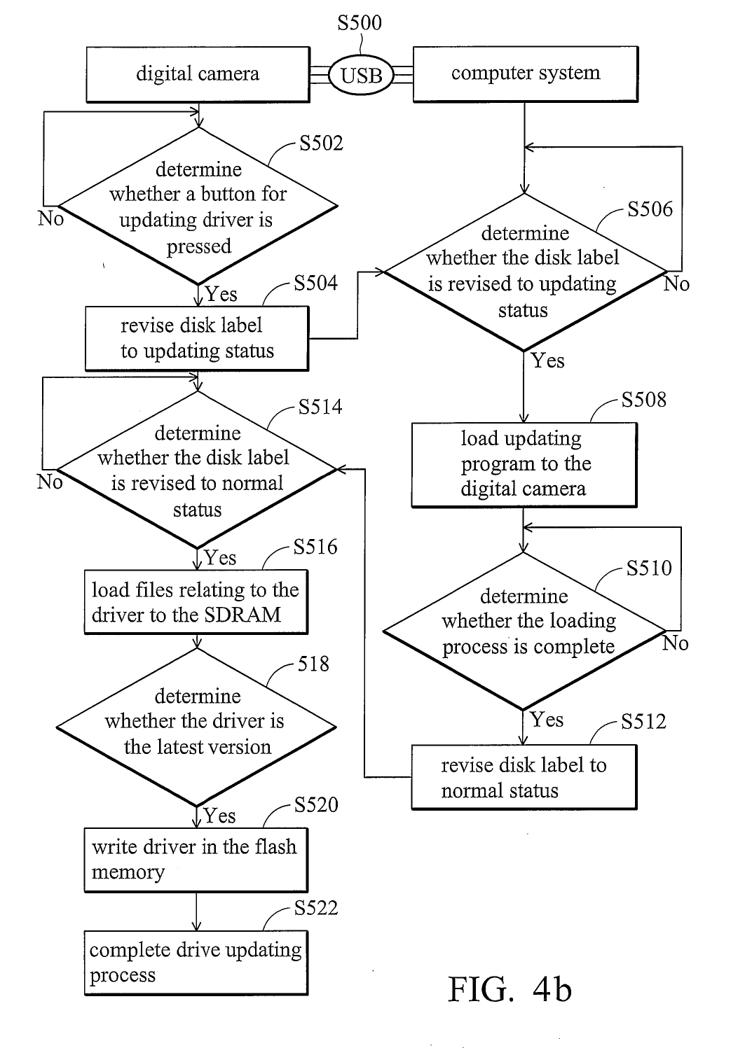

FIG. 4a illustrates an embodiment of a method for processing a driver. According to this embodiment, a method for processing a driver is implemented in a digital camera and a computer system, wherein the digital camera comprises a storage unit for storing a driver. The storage unit of the digital camera serves as a storage device of the computer system after the connection.

Referring to FIG. 4a, the digital camera is connected to a computer system through a USB cable (step S400). An install screen is displayed by the computer system (step S402), and the label is revised from a normal status to an install status (step S404). The label is detected by the digital camera to determine whether the label specifies an install status (step S406).

When the label specifies an install status, the computer system requires installation of a driver. Data is first loaded from a flash memory to a SDRAM (Synchronous Dynamic Random Access Memory) (step S408). The data is then transmitted from the SDRAM to an external memory (step S410). The label is then revised from an install status to a normal status (step S412).

The computer system periodically detects whether the label has been revised to normal status (step S414). When the label has been revised to normal status, a route is directed to the replaceable disk by the computer system (step S416). The driver is installed by the computer system (step S418). After the driver is installed, the digital camera is driven by the computer system (step S420).

As shown in FIG. 4a, the driver of the digital camera can be stored in the digital camera in advance. When the digital camera is connected to the computer system, the driver is loaded from the digital camera to the computer system to install the driver. Thus, failure of a computer system to drive a digital camera due to lack of proper driver can be prevented.

FIG. 4b illustrates another embodiment of a method for processing a driver. According to this embodiment, the digital camera is connected to a computer system through a USB cable (step S500). A storage unit of the digital camera serves as a storage device of the computer system after the connection.

It is determined whether a button for updating a driver of the digital camera is pressed (step S502). When the button for updating a driver of the digital camera is pressed, a label of the storage device (the storage unit of the digital camera) is revised from normal status to update status (step S504). Similarly, the computer system periodically detects whether the label has been revised to update status (step S506). When the label has been revised to update status, an update program is loaded from the computer system to the digital camera (step S508).

It is determined whether the loading process is complete (step S510). After the loading process is complete, the label is restored from an update status to a normal status (step S512). The digital camera periodically detects whether the label has been revised to normal status (step S514). When the label is restored to the normal status, files relating to the driver are loaded into the SDRAM (step S516). It is determined whether the driver is the latest version (step S518). The version comparison step can be executed before the update program is loaded into the digital camera. It can be determined that the update program used to update the driver is the most current version. The driver is then written to the flash memory (step S520) completing the driver update process (step S522).

As shown in FIG. 4b, the driver of the digital camera can be updated by coupling with a computer system, such as a server system provided by a manufacturer. The driver version can thus be confirmed. When the digital camera is linked to another computer system, the updated driver loaded to the digital camera can be transmitted to the linked computer system, and is thereby installed thereon.

Methods and systems of the invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various calibrations and similar arrangements (as would be apparent to those skilled in the art). Therefore, the scope of the appended claims should be accorded the broadest interpretation so as to encompass all such calibrations and similar arrangements.

What is claimed is:

1. A method for processing a driver in a portable electronic device, wherein the driver is stored in a storage unit of the portable electronic device, and the driver drives the portable electronic device, comprising:
coupling the portable electronic device to a computer system, wherein the storage unit of the portable electronic device serves as a storage device of the computer system after the connection;
detecting a label of the storage device, wherein the label specifies a status of the driver; and
processing the driver according to the label.

2. The method of claim 1, wherein the coupling is established through a USB (universal series bus) cable.

3. The method of claim 1, wherein the detecting step is executed by the computer system or the portable electronic device.

4. The method of claim 1, wherein the portable electronic device is a digital camera.

5. The method of claim 1, wherein the label specifies a normal, install, or update status of the driver.

6. The method of claim 5, further comprising the following steps executed before the detecting step:
receiving a driver install signal from the computer system; and
revising the label to specify an install status.

7. The method of claim 6, further comprising the following steps when the label specifies an install status:
loading the driver into the computer system; and
revising the label to specify a normal status.

8. The method of claim 5, further comprising the following steps executed before the detecting step:
receiving a driver update signal from the computer system; and
revising the label to specify an update status.

9. The method of claim 8, further comprising the following steps if the label status is update:
loading an update program from the computer system to the portable electronic device; and
revising the label to specify a normal status.

10. The method of claim 8, further comprising the following steps if the label status is update:
comparing versions of the driver and an update program in the computer system;
when the version of the update program is more current than the driver, Loading the update program from the computer system to the portable electronic device; and
revising the label to specify a normal status.

11. A storage medium for storing a computer program providing a method for processing a driver of claim 1.

12. A system for processing a driver in a portable electronic device, wherein the driver is stored in a storage unit of the portable electronic device, and the driver drives the portable electronic device, comprising:
a connection device, coupling the portable electronic device to a computer system, wherein the storage unit of the portable electronic device serves as a storage device of the computer system after the connection;
a detection device, detecting a label of the storage device, wherein the label specifies a status of the driver; and
a processor, coupled to the detection device, processing the driver according to the label.

13. The system of claim 12, wherein the connection device is a USB (universal series bus) cable.

14. The system of claim 12, wherein the computer system or the portable electronic device comprises the detection device.

15. The system of claim 12, wherein the portable electronic device is a digital camera.

16. The system of claim 12, further comprising a labeling device, coupled to the connection device, writing the label to specify a normal, generating, or update status of the driver, wherein the labeling device is set in the computer system or the portable electronic device.

17. The system of claim 16, wherein, before the detection device detects the label, the labeling device receives a driver install signal from the computer system, and revises the label to specify a generating status.

18. The system of claim 17, wherein, when the label specifies a generating status, the processor loads the driver into the computer system, and revises the label to specify a normal status.

19. The system of claim 16, wherein, before the detection device detects the label, the labeling device receives a driver update signal from the computer system, and revises the label to specify an update status.

20. The system of claim 19, wherein, when the label status is update, the processor loads an update program from the computer system to the portable electronic device, and revises the label to specify a normal status.

21. The system of claim 19, wherein, when the label status is update, the processor compares versions of the driver and an update program in the computer system, loads the update program from the computer system to the portable electronic device when the version of the update program is more current than the driver, and revises the label to specify a normal status.
